(19) United States
(12) Patent Application Publication
(10) Pub. No.: US 2024/0406360 A1
(43) Pub. Date: Dec. 5, 2024

(54) IMAGE ENHANCEMENT PROCESSING METHOD AND APPARATUS, DEVICE AND STORAGE MEDIUM

(71) Applicant: Beijing Baidu Netcom Science Technology Co., Ltd., Beijing (CN)

(72) Inventor: Feiyang LIU, Beijing (CN)

(21) Appl. No.: 18/746,291

(22) Filed: Jun. 18, 2024

(30) Foreign Application Priority Data
Dec. 18, 2023 (CN) 202311745207.7

(51) Int. Cl. H04N 9/64; G06T 5/70; G06T 5/73

(52) U.S. Cl. CPC H04N 9/646; G06T 5/70; G06T 5/73; G06T 2207/10024

(57) ABSTRACT

The present disclosure provides an image enhancement processing method and apparatus, a device and a storage medium, which relate to the field of artificial intelligence technology, especially to the field of cloud computing technology. The specific implementation scheme is: in response to an input image read, obtaining a color space corresponding to the input image and all color pixels of at least one color component in the color space; determining sharpened pixel values respectively corresponding to pixel positions of all the color pixels; determining smoothed sharpened pixel values respectively corresponding to all the pixel positions based on the sharpened pixel values respectively corresponding to the pixel positions of all the color pixels; obtaining a to-be-coded image corresponding to the input image according to the smoothed sharpened pixel values respectively corresponding to all the pixel positions.

### CROSS-REFERENCE TO RELATED APPLICATION

This application claims priority to Chinese Patent Application No. 202311745207.7 filed on Dec. 18, 2023, which is hereby incorporated by reference in its entirety.

### TECHNICAL FIELD

The present disclosure relates to the field of artificial intelligence technology, especially to the field of cloud computing technology. In particular, the present disclosure relates to an image enhancement processing method and apparatus, a device and a storage medium.

### BACKGROUND

At present, there is a consensus on the superiority of the technical framework of preprocessing and enhancing the coding content with medium or low quality before coding. This framework can not only effectively improve the subjective experience of the encoded video, but is also effectively adapted to a variety of coding standards due to its non-invasiveness to the encoder since the pre-processing enhancement module is located outside the coding loop.

Sharpening is a commonly used video enhancement method to improve the subjective quality of videos. The existing sharpening methods applied in encoders are all to obtain an estimation of an optimal encoding performance index based on multiple times of coding, then obtain a corresponding optimal sharpening intensity, and then use the optimal sharpening intensity for sharpening processing.

However, studies of human visual system have revealed that human eyes are insensitive to high-frequency information, which means that contributions of individual pixels of a frame of coding image source to the final subjective experience are not evenly distributed. Although the traditional sharpening algorithm has a self-adaptability, that is, the change of pixels in a flat texture area is small, and the change of pixels in a complex texture area is large. However, this model does not take into account the fact that as a human visual characteristic, no attention is paid to high-frequency information, because in traditional image processing, subjective experience is the only influence factor, but whether it is suitable for a coder to perform further encoding is not considered.

### SUMMARY

The present disclosure provides an image enhancement processing method and apparatus, a device, and a storage medium.

According to a first aspect of the present disclosure, an image enhancement processing method is provided, the method includes:
in response to an input image read, obtaining a color space corresponding to the input image and all color pixels of at least one color component in the color space;
determining sharpened pixel values respectively corresponding to pixel positions of all the color pixels;
determining smoothed sharpened pixel values respectively corresponding to all the pixel positions based on the sharpened pixel values respectively corresponding to the pixel positions of all the color pixels;
obtaining a to-be-coded image corresponding to the input image according to the smoothed sharpened pixel values respectively corresponding to all the pixel positions.

According to a second aspect of the present disclosure, an image enhancement processing apparatus is provided, the apparatus includes:
an acquiring unit, configured to obtain, in response to an input image read, a color space corresponding to the input image and all color pixels of at least one color component in the color space;
a first determining unit, configured to determine sharpened pixel values respectively corresponding to pixel positions of all the color pixels;
a second determining unit, configured to determine smoothed sharpened pixel values respectively corresponding to all the pixel positions based on the sharpened pixel values respectively corresponding to the pixel positions of all the color pixels;
a processing unit, configured to obtain a to-be-coded image corresponding to the input image according to the smoothed sharpened pixel values respectively corresponding to all the pixel positions.

According to a third aspect of the present disclosure, an electronic device is provided, including:
at least one processor; and
a memory communicatively connected with at least one processor;
where the memory stores an instruction executable by the at least one processor, and the instruction is executed by the at least one processor to enable the at least one processor to execute the method according to any one of the above.

According to a fourth aspect of the present disclosure, a non-transitory computer readable storage medium storing a computer instruction is provided, where the computer instruction is configured to enable a computer to execute the method according to any one of the above.

According to a fifth aspect of the present disclosure, a computer program product including a computer program is provided, the computer program is stored in a readable storage medium, at least one processor of the electronic device may read the computer program from the readable storage medium, and the at least one processor executes the computer program to enable the electronic device to execute the method described in the first aspect.

It should be understood that the content described in this part is not intended to identify critical or significant features of embodiments of the present disclosure, nor is it intended to limit the scope of the present disclosure. Other features of the present disclosure will be made easier to understand by the following instructions.

### BRIEF DESCRIPTION OF DRAWINGS

Drawings are for a better understanding of the present scheme and do not constitute a limitation of the present disclosure.

FIG. 1 is a flowchart of an image enhancement processing method provided by an embodiment of the present disclosure.

FIG. 2 is a flowchart of an optional image enhancement processing method provided by an embodiment of the present disclosure.

FIG. 3 is a flowchart of an optional image enhancement processing method provided by an embodiment of the present disclosure.

FIG. 4 is a flowchart of an optional image enhancement processing method provided by an embodiment of the present disclosure.

FIG. 5 is a flowchart of an optional image enhancement processing method provided by an embodiment of the present disclosure.

FIG. 6 is a flowchart of an optional image enhancement processing method provided by an embodiment of the present disclosure.

FIG. 7 is a schematic frame diagram of an optional image enhancement processing apparatus provided by an embodiment of the present disclosure.

FIG. 8 is a block diagram of an electronic device configured to implement an image enhancement processing method of an embodiment of the present disclosure.

### DESCRIPTION OF EMBODIMENTS

Exemplary embodiments of the present disclosure are explained below combining with the drawings, which include various details of embodiments of the present disclosure for understanding and should be considered exemplary only. Therefore, ordinary person skilled in the art should be aware that various changes and modifications may be made to the embodiments described herein without departing from the scope and spirit of the present disclosure. Similarly, for clarity and conciseness, descriptions of known functions and structures have been omitted in the following descriptions.

Firstly, terms involved in the present application is explained.

Visual Multimethod Assessment Fusion (VMAF) is a system for subjective video quality evaluation, through an introduction of deep learning mechanism, video quality is scored in a way more consistent with human vision.

At present, the industry has reached a consensus on the superiority of the technical framework of preprocessing and enhancing the coding content with medium or low quality before coding. This framework can not only effectively improve the subjective experience of the encoded video, but is also effectively adapted to a variety of coding standards due to its non-invasiveness to the encoder since the pre-processing enhancement module is located outside the coding loop.

Sharpening is a commonly used video enhancement method to improve the subjective quality of videos. The existing sharpening methods applied in encoders are all to obtain an estimation of an optimal encoding performance index based on multiple times of coding, then obtain a corresponding optimal sharpening intensity, and then use the optimal sharpening intensity for sharpening processing. In the existing methods, generally a search space is given, then a violent search is conducted in the search space; or a small search space is traversed first, then a sharpening intensity and rate-distortion joint optimization goal are modelled, and then the model is solved. This kind of method is directly related to the final optimization goal, but the high complexity brought by the traversal of the search space is difficult to be accepted in practical applications, especially in low latency coding scenarios.

In addition, studies of human visual system have revealed that human eyes are insensitive to high-frequency information, which means contributions of individual pixels of a frame of coding image source to the final subjective experience are not evenly distributed. Although the traditional sharpening algorithm has a self-adaptability, that is, the change of pixels in a flat texture area is small, and the change of pixels in a complex texture area is large. However, this model does not take into account the fact that as a human visual characteristic, no attention is paid to high-frequency information, because in traditional image processing, subjective experience is the only influence factor, but whether it is suitable for a coder to perform further encoding is not considered.

To solve the above problems, the present disclosure provides an image enhancement processing method and apparatus, a device and a storage medium, which are applied in the field of artificial intelligence technology, especially relate to the field of cloud computing technology. In the present disclosure, through further smoothing of sharpened pixel values respectively corresponding to pixel positions of all color pixels, the noise of the sharpened pixel values is reduced, thus taking advantage of the characteristic of the human visual system in principle to suppress part(s) insensitive to human eyes and retain part(s) sensitive to the human eyes, so as to improve the subjective experience and reduce the damage to the spatial redundancy of the coding information source. Due to an introduction of the prior information, multiple times of coding based on the posterior method can be avoided, and the high computational complexity can be reduced, so as to achieve an efficient enhancement to a coding source in a low-delay coding scenario, and gain advantages over competitive products.

According to the technique of the present disclosure, firstly, a color space corresponding to the input image and all color pixels of at least one color component in the color space are obtained in response to an input image read; secondly, sharpened pixel values respectively corresponding to pixel positions of all the color pixels are determined by sharpening an original pixel value of each color pixel, which may improve details and contrast of the input image to make the image clearer. After that, in order to eliminate the noise and artifacts that may be generated in the sharpening process and make the image smoother, in the present disclosure, smoothed sharpened pixel values respectively corresponding to all the pixel positions are determined based on the sharpened pixel values respectively corresponding to the pixel positions of all the color pixels. The smoothed sharpened pixel value is a sharpened pixel value after smoothing, the smoothed sharpened pixel value usually has a lower amplitude than the sharpened pixel value, which may reduce noise and artifacts in the image. Finally, a to-be-coded image corresponding to the input image is obtained according to the smoothed sharpened pixel values respectively corresponding to all the pixel positions. According to the image enhancement processing method before coding provided in the present disclosure, the high computational complexity may be reduced, the noise and artifacts that may be generated in the sharpening process may be eliminated, the part(s) which is not conducive to coding and not easily perceived by human eyes are suppressed, thus making the image smoother, consequently improving the subjective experience and reducing the damage to the spatial redundancy for the coding source.

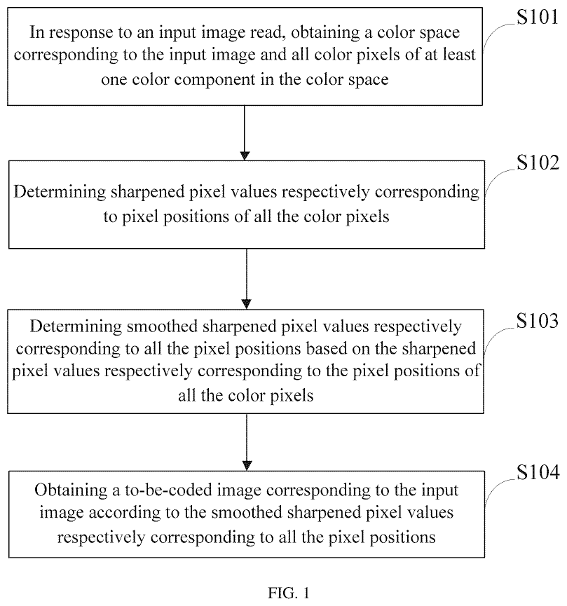

FIG. 1 is a flowchart of an image enhancement processing method provided by an embodiment of the present disclosure, as shown in FIG. 1, an image enhancement processing method is provided in the present disclosure, including the following method steps.
S101, in response to an input image read, obtaining a color space corresponding to the input image and all color pixels of at least one color component in the color space.
S102, determining sharpened pixel values respectively corresponding to pixel positions of all the color pixels.
S103, determining smoothed sharpened pixel values respectively corresponding to all the pixel positions based on the sharpened pixel values respectively corresponding to the pixel positions of all the color pixels.
S104, obtaining a to-be-coded image corresponding to the input image according to the smoothed sharpened pixel values respectively corresponding to all the pixel positions.

Optionally, in an example of the present disclosure, for example, an input image input from an external network or a device such as a hard disk is three-dimensional data including a width, a height, and the number of color channels, and a certain color component is a two-dimensional data plane including a width and a height.

Optionally, a color space is a mathematical model used to describe colors, and common color spaces are RGB, YCbCr, HSV, etc. A color component is a dimension in the color space that is used to represent a certain property of a color, such as R (a red component), G (a green component) and B (a blue component) corresponding to an RGB color space. A color pixel is the smallest unit in an image, and each color pixel has one or more values for color component(s), for representing the color of the pixel. For example, each color pixel in the RGB color space has values for three color components, which represent intensities of red, green, and blue, respectively.

In an example, if an initial color space of an input image is RGB and a target color space is YCbCr, the RGB value of each color pixel of the input image needs to be mathematically transformed to obtain the corresponding YCbCr value. Then, at least one color component, such as a brightness component, is selected as needed, and pixel values of all pixel positions of this component are acquired. In this way, by converting and selecting the color space of the input image, color information of the input image is extracted, thus providing a basis for the subsequent image enhancement processing.

It can be understood that sharpening is an image processing technique that enhances details and contrast of an image and improves the clarity of the image by increasing a difference between light and dark on edges and contours in the image. In an example of the present disclosure, the sharpened pixel value is obtained by sharpening the color pixel value to highlight the edges and contours in the image. By sharpening the pixel value of each color pixel, the details and contrast of the image are improved, and the image is clearer.

After that, since noise refers to random or irregular changes in brightness or color of an image, it will affect the quality and visual effect of the image. An artifact is an unreal or unnatural phenomena in an image, such as jagged teeth, ringing, halo, etc., which affects the authenticity and aesthetics of the image. In order to eliminate the noise and artifacts that may be generated in the sharpening process and make the image smoother, an embodiment of the present disclosure also determines smoothed sharpened pixel values respectively corresponding to all the pixel positions based on the sharpened pixel values respectively corresponding to the pixel positions of all the color pixels.

In an embodiment of the present disclosure, smoothing is an image processing that improves the smoothness of an image by reducing noise and artifacts in the image. The smoothed sharpened pixel value is a sharpened pixel value after the smoothing process, which will usually have a lower amplitude than the sharpened pixel value to preserve the spatial redundancy in the image.

Optionally, the above to-be-coded image is an image to be coded/encoded, where coding/encoding is to reduce the data size of the image or change the representation of the image by compressing or transforming the image. Generally, a coded image will take up less storage space or bandwidth than the input image, or has a characterized of more suitable for specific use. After that, the to-be-coded image after image enhancement processing is coded by an encoder. According to the image enhancement method before coding provided by the present disclosure, the noise and artifacts that may be generated in the sharpening process can be eliminated, the part(s) which is not conducive to coding and not easily perceived by the human eye can be suppressed, thus making the image smoother.

Based on the aforementioned human visual characteristics and coding framework's characteristics, in the present disclosure, a smoothing and sharpening algorithm oriented to subjective experience and coding performance is realized, and the high complexity caused by multiple times of coding and the posterior calculation of VMAF index are avoided at the same time, so the method can be applied in practical coding, especially in delay-sensitive application scenarios. In the present disclosure, based on the prior knowledge of the human visual system and source coding, the part of the enhanced information that is conducive to improving the subjective experience and does not affect the spatial redundancy of pixels in principle is directly obtained. The present disclosure focuses on suppressing the part(s) which is not conducive to coding and not easily perceived by the human eyes in the sharpening algorithm.

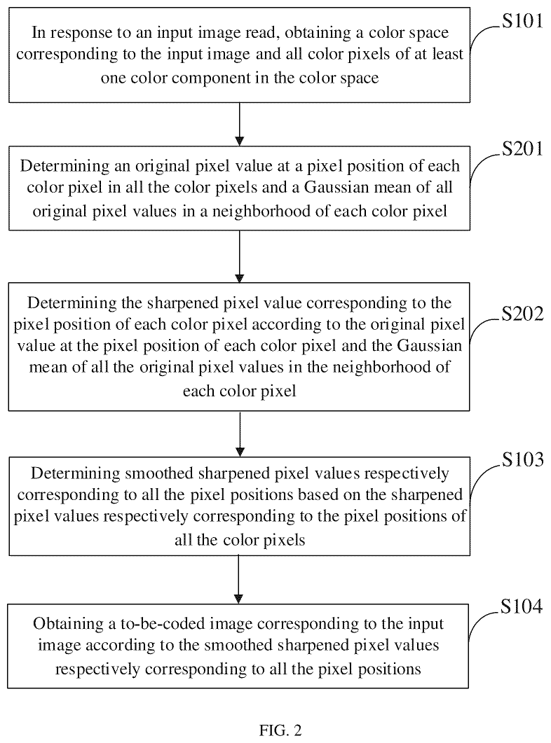

In an example, FIG. 2 is a flowchart of an optional image enhancement processing method provided by an embodiment of the present disclosure, as shown in FIG. 2, the determining the sharpened pixel values respectively corresponding to the pixel positions of all the color pixels includes:
S201, determining an original pixel value at a pixel position of each color pixel in all the color pixels and a Gaussian mean of all original pixel values in a neighborhood of each color pixel;
S202, determining the sharpened pixel value corresponding to the pixel position of each color pixel according to the original pixel value at the pixel position of each color pixel and the Gaussian mean of all the original pixel values in the neighborhood of each color pixel.

Optionally, the original pixel value is the pixel value of each color pixel in the input image, which reflects the color intensity of that pixel. A neighborhood refers to other pixels in a certain range around a pixel, and can be usually represented by a rectangular window. For example, the size of the neighborhood can be a 3×3 rectangular window.

Optionally, the Gaussian mean is an average of the pixels obtained by taking a weighted average of the pixel values in the neighborhood of the pixel to remove noise and details. The weights of the weighted average are determined according to the Gaussian function, which is a commonly used probability distribution function whose shape resembles a bell-shaped curve with one peak and two symmetric tails. The characteristic of the Gaussian function is that a pixel closer to the peak will have a larger weight and a pixel farther from the peak will have a smaller weight. This ensures that the pixel values in the neighborhood will not be processed equally, but will be adjusted appropriately according to their distances from the center pixel.

Using the above example of the present disclosure, the original pixel value is obtained by reading the pixel value of each color pixel of the input image, and then the Gaussian mean of all pixel values in the neighborhood of each pixel is calculated according to the preset size of the neighborhood and parameter(s) of the Gaussian function. In this way, the noise and details in the image are eliminated by performing Gaussian smoothing processing on the original pixel value of each color pixel, thus providing a smooth basis for the subsequent sharpening process.

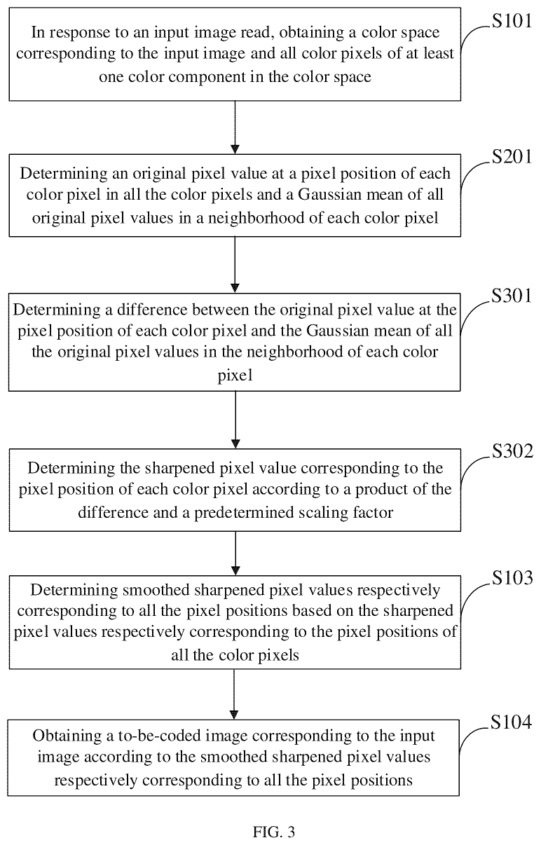

In order to enhance the details and contrast of the image to make the image clearer, optionally, in one example, FIG. 3 is a flowchart of an optional image enhancement processing method provided by an embodiment of the present disclosure. As shown in FIG. 3, the determining the sharpened pixel value corresponding to the pixel position of each color pixel according to the original pixel value at the pixel position of each color pixel and the Gaussian mean of all the original pixel values in the neighborhood of each color pixel includes:
S301, determining a difference between the original pixel value at the pixel position of each color pixel and the Gaussian mean of all the original pixel values in the neighborhood of each color pixel;
S302, determining the sharpened pixel value corresponding to the pixel position of each color pixel according to a product of the difference and a predetermined scaling factor.

Optionally, the difference between the original pixel value at the pixel position of the aforementioned each color pixel and the Gaussian mean reflects details and contrast of the pixel at that pixel position, and by multiplying the difference with a scaling factor, the magnitude of the difference can be enlarged or reduced, thereby enhancing or reducing the sharpening effect of the pixel.

Optionally, the above scaling factor is an adjustable parameter that determines the intensity of sharpening, usually between 0 and 2, the greater the value, the more obvious the sharpening effect, the closer to 0, the weaker the sharpening effect.

In an example of the present disclosure, mathematical operation is performed with the difference between the original pixel value at the pixel position of each color pixel and the Gaussian mean of all the original pixel values in the neighborhood of each color pixel to obtain the sharpened pixel value corresponding to the pixel position of each color pixel.

Through the above example, sharpening processing of the pixel value of each color pixel can improve the details and contrast of the image, thus making the image clearer.

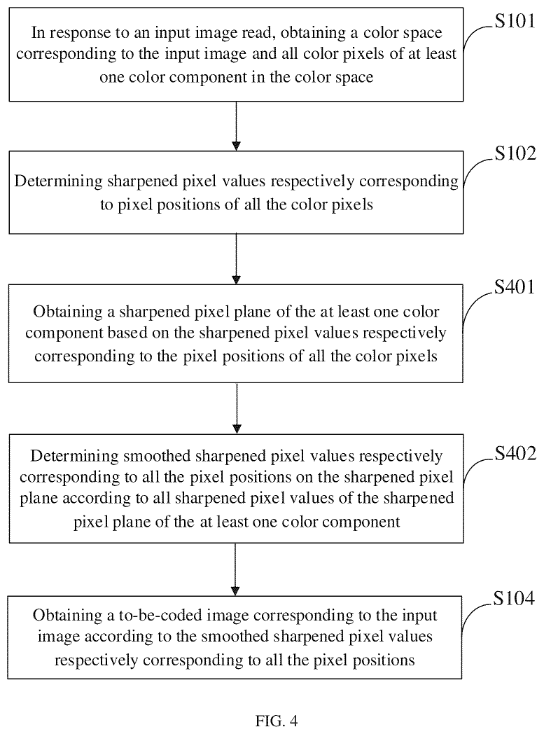

In an optional example, FIG. 4 is a flowchart of an optional image enhancement processing method provided by an embodiment of the present disclosure, as shown in FIG. 4, the determining the smoothed sharpened pixel values respectively corresponding to all the pixel positions based on the sharpened pixel values respectively corresponding to the pixel positions of all the color pixels includes:
S401, obtaining a sharpened pixel plane of the at least one color component based on the sharpened pixel values respectively corresponding to the pixel positions of all the color pixels;
S402, determining smoothed sharpened pixel values respectively corresponding to all the pixel positions on the sharpened pixel plane according to all sharpened pixel values of the sharpened pixel plane of the at least one color component.

Optionally, the sharpened pixel plane is a two-dimensional matrix where each element represents a sharpened pixel value and its position corresponds to the position of the color pixel in the input image.

In an optional example, through storing or transmitting the sharpened pixel values for each color component, and then arranging the sharpened pixel values for each color component into a sharpened pixel plane in a certain order and format according to the color space and bit depth of the input image. For example, if the color space of the input image is YCbCr and the bit depth is 8 bits, then the sharpened pixel value of each color pixel is a signed integer between −255 and 255, and each sharpened pixel plane is a two-dimensional matrix of sharpened pixel values at different pixel positions, indicating the intensities of the sharpened pixel values of the corresponding color component.

It should be noted that in an example of the present disclosure, the above smoothed sharpened pixel value is the sharpened pixel value after smoothing processing, which usually has a lower amplitude than the sharpened pixel value to retain the details and contrast in the image.

Then all the sharpened pixel values on the sharpened pixel plane are processed by Gaussian smoothing to obtain the smoothed sharpened pixel values respectively corresponding to all pixel positions on the plane. In this way, noise and artifacts that may be generated during sharpening can be eliminated, resulting in a smoother image. Gaussian smoothing is a smoothing algorithm that removes noise and artifacts by taking a weighted average of the pixel values in the neighborhood of the pixel to obtain the average value of the pixel.

In another optional example, the determining the smoothed sharpened pixel values respectively corresponding to all the pixel positions on the sharpened pixel plane according to all the sharpened pixel values of the sharpened pixel plane of the at least one color component includes:
determining the smoothed sharpened pixel values respectively corresponding to all the pixel positions on the sharpened pixel plane according to a Gaussian mean of all the sharpened pixel values of the sharpened pixel plane of the at least one color component.

In the example of the present disclose, mathematical operation is performed with each sharpened pixel value on the sharpened pixel plane and the Gaussian mean of all sharpened pixel values in the neighborhood of each sharpened pixel value to obtain the smoothed sharpened pixel value corresponding to each sharpened pixel value.

Optionally, in the present example, the Gaussian mean is calculated in the same way as the previous Gaussian mean, except that the object is changed from the original pixel value to the sharpened pixel value. The mathematical operation is performed in the same way as the previous mathematical operation, except that the objects are changed from original pixel values and Gaussian mean to sharpened pixel values and Gaussian mean.

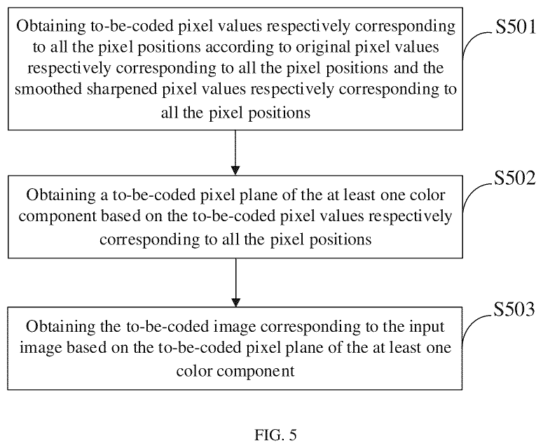

As an optional example, FIG. 5 is a flowchart of an optional image enhancement processing method provided by an embodiment of the present disclosure, as shown in FIG. 5, the obtaining the to-be-coded image corresponding to the input image according to the smoothed sharpened pixel values respectively corresponding to all the pixel positions includes:
S501, obtaining to-be-coded pixel values respectively corresponding to all the pixel positions according to original pixel values respectively corresponding to all the pixel positions and the smoothed sharpened pixel values respectively corresponding to all the pixel positions;
S502, obtaining a to-be-coded pixel plane of the at least one color component based on the to-be-coded pixel values respectively corresponding to all the pixel positions;
S503, obtaining the to-be-coded image corresponding to the input image based on the to-be-coded pixel plane of the at least one color component.

In the example of the present disclosure, the to-be-coded pixel value at each pixel position is obtained by performing mathematical operation on the original pixel values and smoothed sharpened pixel values respectively corresponding to all pixel positions. There can be many ways for implementing the mathematical operation, for example, using the addition operation, difference operation, product operation, proportion operation, etc., and the specific way depends on the characteristics of the image and requirements.

For example, in an example of the present disclosure, the original pixel values and smoothed sharpened pixel values respectively corresponding to all pixel positions are added, so the original pixel values and smoothed sharpened pixel values can be fused. Then, the to-be-coded pixel value at each pixel position obtained by the addition forms the to-be-coded pixel plane, where the plane includes all the color information and enhancement information of the image.

Optionally, the to-be-coded pixel plane is a two-dimensional matrix of the to-be-coded pixel values according to a certain color component, where each element represents a to-be-coded pixel value and its position corresponds to the pixel position in the input image.

In order to separate the to-be-coded pixel values according to different color components, different to-be-coded pixel planes are obtained, so that different color components can be coded differently. For example, in an optional example, for each to-be-coded pixel value in the to-be-coded pixel plane, each to-be-coded pixel value is decomposed into to-be-coded pixel values of different color components according to the color space and bit depth of the input image, which are then arranged into different to-be-coded pixel planes in a certain order and format. For example, if the color space of the input image is RGB and the bit depth is 8 bits, then each to-be-coded pixel value is a tuple of three to-be-coded pixel values representing intensities of red, green, and blue, and each to-be-coded pixel plane is a matrix of to-be-coded pixel values, a plane representing the red, green and blue, respectively.

Using the above example, the to-be-coded pixel values are separated according to different color components to obtain different to-be-coded pixel planes. Then, a to-be-coded pixel plane is formed according to the to-be-coded pixel value at each pixel position, and then the plane is coded to obtain the to-be-coded image corresponding to the input image. In this way, the amount of image data can be reduced or the format of the image can be changed by coding the to-be-coded pixel plane, to facilitate the storage or transmission of the image.

In an example, step S501 above, obtaining the to-be-coded pixel values respectively corresponding to all the pixel positions according to the original pixel values respectively corresponding to all the pixel positions and the smoothed sharpened pixel values respectively corresponding to all the pixel positions includes:
a), acquiring a bit depth of the input image and an effective range corresponding to the bit depth;
b), determining a sum value of the original pixel values and the smoothed sharpened pixel values respectively corresponding to all the pixel positions;
c), if a sum value corresponding to any one of the pixel positions exceeds the effective range, truncating the sum value that exceeds the effective range to the effective range to obtain the to-be-coded pixel values respectively corresponding to all the pixel positions.

In an example of the present disclosure, the bit depth of the input image and the corresponding effective range of the bit depth can be obtained by reading the metadata of the input image (metadata refers to the additional information of the image, usually including the format, size, resolution, color space and other information of the image). In this way, the range of the to-be-coded pixel value can be determined, and the distortion or error of the image due to the range of the bit depth being beyond the allowable range can be avoided.

Optionally, in an example of the present disclosure, the bit depth refers to the log value of the number of colors that can be represented by each pixel, which is usually represented by the number of bits, such as 8 bits, 16 bits, 24 bits, etc.

Optionally, in an example of the present disclosure, the effective range refers to the maximum and minimum values of the color intensity that can be represented by each pixel, which is usually represented by a number, such as 0 to 255, 0 to 65535, etc.

Optionally, the above original pixel value refers to the color intensity value at each pixel position in the input image, and the smoothed sharpened pixel value refers to the color intensity value at the pixel position after the sharpening and smoothing processing. The sum value is the sum result of the original pixel value and the smoothed sharpened pixel value, which is usually higher or lower than the original pixel value or the smoothed sharpened pixel value, to highlight the edges and contours in the image, while maintaining the color saturation and brightness of the image.

In the example of the present disclosure, in order to fuse the original pixel value and the smoothed sharpened pixel value, a comprehensive pixel value is obtained to retain the color information and enhancement information of the image.

Optionally, in an example of the present disclosure, the bit depth refers to the log value of the number of colors that can be represented by each pixel, which is usually represented by the number of bits, such as 8 bits, 16 bits, 24 bits, etc. The effective range is the maximum and minimum values of color intensity that can be represented by each pixel, which is usually represented by a number, such as 0 to 255, 0 to 65535, and so on.

Furthermore, in an example of the present disclosure, in order to ensure the effectiveness of the sum value and avoid image distortion or error caused by exceeding the effective range, it is possible to judge the sum value corresponding to a respective pixel position, if the sum value corresponding to the pixel position exceeds the effective range allowed by the bit depth of the input image, then the sum value corresponding to the pixel position is truncated to the maximum value or minimum value of the effective range, otherwise the sum value corresponding to the pixel position is kept unchanged. Then, a to-be-coded pixel plane is formed according to the to-be-coded pixel value of each color component, and then the plane is coded to obtain the to-be-coded image corresponding to the input image.

For example, if the bit-depth of the input image is 8 bits, then the effective range is 0 to 255. If the sum value at a pixel position is 300, then the value of the sum value at this pixel position is truncated to 255. If the sum value at a pixel position is −10, then the value of the sum value at this pixel position is truncated to 0. If the sum at a pixel location is 100, then the sum at this pixel location is kept as 100.

Through the above examples of the present disclosure, the pixel value beyond the effective range is forced to be assigned to make it equal to the maximum or minimum value of the effective range, so as to ensure the effectiveness of the sum value and avoid image distortion or error caused by exceeding the effective range.

There is an optional example, in which the obtaining of the color space corresponding to the input image includes:
S1010, obtaining an initial color space of the input image;
S1011, if the initial color space is not a target color space, performing conversion processing on the initial color space to obtain the color space corresponding to the input image;
S1012, if the initial color space is the target color space, taking the target color space as the color space corresponding to the input image.

Optionally, the above initial color space refers to the initial color space of the input image, which is a mathematical model used to describe the colors. Common color Spaces are RGB, YCbCr, HSV, etc.

An optional implementation manner is to obtain the initial color space of the input image by reading the metadata of the input image. This metadata refers to additional information about an image, usually including information about the format, size, resolution, color space of the image, and so on.

Optionally, the above target color space refers to the final color space of the image enhancement processing, which is a mathematical model used to describe the colors, usually different from the initial color space, for example, the RGB color space can be converted to the YCbCr color space, or the YCbCr color space can be converted to the RGB color space, etc.

Optionally, a conversion of color spaces changes the color space of an image by applying a mathematical conversion to the color value of each pixel in the image.

In an implementable example, it is possible to judge whether the initial color space of the input image is the same as the target color space, and if so, then the target color space is directly used as the color space corresponding to the input image. If not, a conversion processing is performed on the color space. For example, mathematical transformation is performed, according to the conversion formula between the initial color space and the target color space, on the color value of each pixel of the input image to obtain a new color value of each pixel, and then according to the new color value, an image with the new color space is formed as the color space corresponding to the input image.

In another example, if the initial color space of the input image is already the target color space, there is no need to perform conversion processing, and the target color space is directly used as the color space corresponding to the input image, thus avoiding unnecessary conversion processing and saving time and resources.

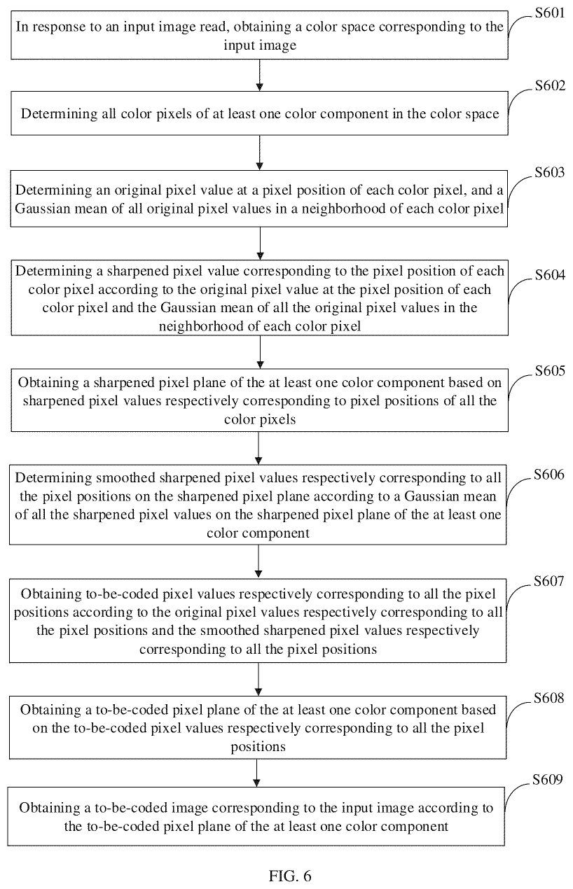

In an optional embodiment, FIG. 6 is a flowchart of an optional image enhancement processing method provided by an embodiment of the present disclosure, as shown in FIG. 6, an optional image enhancement processing method includes the following steps.
S601, in response to an input image read, obtaining a color space corresponding to the input image.

In the above step S601, the initial color space of the input image is obtained first; if the initial color space is not the target color space, the initial color space undergoes conversion processing to obtain the color space corresponding to the input image. If the initial color space is the target color space, the target color space is taken as the color space corresponding to the input image.
S602, determining all color pixels of at least one color component in the color space.
S603, determining an original pixel value at a pixel position of each color pixel, and a Gaussian mean of all original pixel values in a neighborhood of each color pixel.
S604, determining a sharpened pixel value corresponding to the pixel position of each color pixel according to the original pixel value at the pixel position of each color pixel and the Gaussian mean of all the original pixel values in the neighborhood of each color pixel.

In the above step S604, the difference between the original pixel value at the pixel position of each color pixel and the Gaussian mean is determined, and the sharpened pixel value corresponding to the pixel position of each color pixel is determined by multiplying this difference with a predetermined scaling factor (an adjustable parameter that determines the intensity of sharpening, typically between 0 and 2).
S605, obtaining a sharpened pixel plane of the at least one color component based on sharpened pixel values respectively corresponding to pixel positions of all the color pixels.
S606, determining smoothed sharpened pixel values respectively corresponding to all the pixel positions on the sharpened pixel plane according to a Gaussian mean of all the sharpened pixel values on the sharpened pixel plane of the at least one color component.

In the above step S606, mathematical operation is performed with each sharpened pixel value on the sharpened pixel plane and the Gaussian mean of all sharpened pixel values in the neighborhood of each sharpened pixel value, to obtain the smoothed sharpened pixel value corresponding to each sharpened pixel value.
S607, obtaining to-be-coded pixel values respectively corresponding to all the pixel positions according to the original pixel values respectively corresponding to all the pixel positions and the smoothed sharpened pixel values respectively corresponding to all the pixel positions.
S608, obtaining a to-be-coded pixel plane of the at least one color component based on the to-be-coded pixel values respectively corresponding to all the pixel positions.
S609, obtaining a to-be-coded image corresponding to the input image according to the to-be-coded pixel plane of the at least one color component.

The main differences between the present disclosure and the existing video enhancement methods are as follows.
(1) The existing sharpening methods focus on the search and solving of the optimal sharpening intensity, which is for processing the content of the video and obtained by using a corresponding sharpening intensity in a given search space, and then calculating a corresponding optimization target index, the process requires multiple times of coding and multiple computations of quality index, and has high complexity.

The present disclosure focuses on extracting the part of the traditional sharpening algorithm that effectively improves the subjective experience of the video, and suppressing the part(s) that is not conducive to coding and not easily perceived by human eyes, which is an optimization of the sharpening algorithm per se.
(2) Different from the traditional posterior enhancement processing framework, the present disclosure is based on the prior information of the characteristics of the human visual system and the characteristics of the coding frame, multiple times of coding are no longer needed, which avoids the delay caused by multiple times of coding and is suitable for delay-sensitive application scenarios.
(3) Based on the characteristics of the human visual system, the source coding theory is taken as the starting point, which is deeply combined with the subjective experience, so as to become adaptable to the coding task of jointly optimizing the rate-distortion performance.

In the technical solutions of the present disclosure, the collection, storage, use, processing, transmission, provision and disclosure of user's personal information are in accordance with the provisions of relevant laws and regulations, and do not violate the public order and good customs.

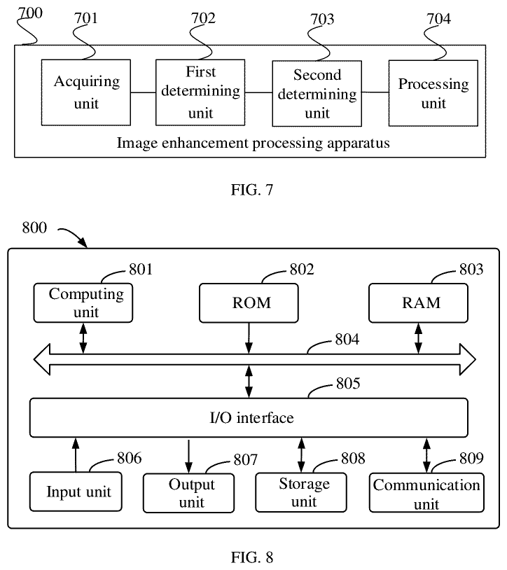

According to embodiments of the present disclosure, FIG. 7 is a schematic frame diagram of an optional image enhancement processing apparatus provided by an embodiment of the present disclosure, as shown in FIG. 7, an image enhancement processing apparatus is also provided, the image enhancement processing apparatus 700, including:
an acquiring unit 701, configured to obtain, in response to an input image read, a color space corresponding to the input image and all color pixels of at least one color component in the color space;
a first determining unit 702, configured to determine sharpened pixel values respectively corresponding to pixel positions of all the color pixels;
a second determining unit 703, configured to determine smoothed sharpened pixel values respectively corresponding to all the pixel positions based on the sharpened pixel values respectively corresponding to the pixel positions of all the color pixels;
a processing unit 704, configured to obtain a to-be-coded image corresponding to the input image according to the smoothed sharpened pixel values respectively corresponding to all the pixel positions.

According to one or more optional embodiments of the present disclosure, the first determining unit includes:
a first determining subunit, configured to determine an original pixel value at a pixel position of each color pixel in all the color pixels and a Gaussian mean of all original pixel values in a neighborhood of each color pixel;
a second determining subunit, configured to determine the sharpened pixel value corresponding to the pixel position of each color pixel according to the original pixel value at the pixel position of each color pixel and the Gaussian mean of all the original pixel values in the neighborhood of each color pixel.

According to one or more optional embodiments of the present disclosure, the second determining subunit includes:
a first determining submodule, configured to determine a difference between the original pixel value at the pixel position of each color pixel and the Gaussian mean of all the original pixel values in the neighborhood of each color pixel;
a second determining submodule, configured to determine the sharpened pixel value corresponding to the pixel position of each color pixel according to a product of the difference and a predetermined scaling factor.

According to one or more optional embodiments of the present disclosure, the second determining unit includes:
a first generating subunit, configured to obtain a sharpened pixel plane of the at least one color component based on the sharpened pixel values respectively corresponding to the pixel positions of all the color pixels;
a third determining subunit, configured to determine smoothed sharpened pixel values respectively corresponding to all the pixel positions on the sharpened pixel plane according to all sharpened pixel values of the sharpened pixel plane of the at least one color component.

According to one or more optional embodiments of the present disclosure, the third determining subunit includes:
a third determining submodule, configured to determine the smoothed sharpened pixel values respectively corresponding to all the pixel positions on the sharpened pixel plane according to a Gaussian mean of all the sharpened pixel values of the sharpened pixel plane of the at least one color component.

According to one or more optional embodiments of the present disclosure, the processing unit includes:
a computing subunit, configured to obtain to-be-coded pixel values respectively corresponding to all the pixel positions according to original pixel values respectively corresponding to all the pixel positions and the smoothed sharpened pixel values respectively corresponding to all the pixel positions;
a second generating subunit, configured to obtain a to-be-coded pixel plane of the at least one color component based on the to-be-coded pixel values respectively corresponding to all the pixel positions;
a processing subunit, configured to obtain the to-be-coded image corresponding to the input image based on the to-be-coded pixel plane of the at least one color component.

According to one or more optional embodiments of the present disclosure, the computing subunit includes:
an acquiring submodule, configured to acquire a bit depth of the input image and an effective range corresponding to the bit depth;
a computing submodule, configured to determine a sum value of the original pixel values and the smoothed sharpened pixel values respectively corresponding to all the pixel positions;
a truncation processing submodule, configured to: if a sum value corresponding to any one of the pixel positions exceeds the effective range, truncate the sum value that exceeds the effective range to the effective range to obtain the to-be-coded pixel values respectively corresponding to all the pixel positions.

According to one or more optional embodiments of the present disclosure, the acquiring unit includes:
a first acquiring subunit, configured to acquire an initial color space of the input image;
a second acquiring subunit, configured to perform conversion processing on the initial color space to obtain the color space corresponding to the input image, if the initial color space is not a target color space;
a third acquiring subunit, configured to take the target color space as the color space corresponding to the input image, if the initial color space is the target color space.

According to embodiments of the present disclosure, an electronic device, a readable storage medium, and a computer program product are provided in the present disclosure.

According to embodiments of the present disclosure, a non-transitory computer readable storage medium storing computer instructions is provided in the present disclosure, where the computer instructions are configured to enable a computer to execute any of the methods above.

According to embodiments of the present disclosure, a computer program product including a computer program is provided, the computer program is stored in a readable storage medium, at least one processor of the electronic device may read the computer program from the readable storage medium, and the at least one processor executes the computer program to enable the electronic device to execute the method described in the first aspect.

According to embodiments of the present disclosure, an electronic device is provided in the present disclosure, and FIG. 8 shows a schematic block diagram of an example electronic device 800 which can be configured to implement the embodiments of the present disclosure. The electronic device is intended to represent various forms of digital computers, for example, a laptop, a desktop computer, a workstation, a personal digital assistant, a server, a blade server, a mainframe computer, and other suitable computers. The electronic device may also represent various forms of mobile apparatuses, for example, personal digital processing, a cellular telephone, a smart phone, a wearable device, and other similar computing apparatuses. Components, connections and relationships thereof, and functions thereof shown herein are used as examples only, and are not intended to limit implementations of the present disclosure described and/or claimed herein.

As shown in FIG. 8, the device 800 includes a computing unit 801 which can perform various appropriate actions and processes according to a computer program stored in a read only memory (ROM) 802 or loaded from a storage unit 808 into a random access memory (RAM) 803. In the RAM 803, various programs and data required for operations of the device 800 may also be stored. The computing unit 801, the ROM 802, and the RAM 803 are connected to each other via a bus 804. An input/output (I/O) interface 805 is also connected to the bus 804.

A plurality of components in the device 800 are connected to the I/O interface 805, including: an input unit 806, for example, a keyboard, mouse, etc.; an output unit 807, for example, various types of displays, speakers, etc.; a storage unit 808, for example, a magnetic disk, an optical disk, etc.; and a communication unit 809, for example, a network card, a modem, a wireless communication transceiver, etc. The communication unit 809 allows the device 800 to exchange information/data with other devices via a computer network such as the Internet and/or various telecommunication networks.

The computing unit 801 may be various general-purpose and/or dedicated processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 801 performs the various methods and processes described above, for example, the image enhancement processing method. For example, in some embodiments, the image enhancement processing method may be implemented as a computer software program which is tangibly contained in a machine readable medium, for example, the storage unit 808. In some embodiments, some or all of computer programs may be loaded and/or installed onto the device 800 via the ROM 802 and/or the communication unit 809. When the computer program is loaded into the RAM 803 and executed by the computing unit 801, one or more steps of the image enhancement processing method described above may be executed. Alternatively, in other embodiments, the computing unit 801 may be configured to perform the image enhancement processing method in any other suitable means (e.g., by means of firmware).

Various implementation modes of systems and techniques described above herein may be realized in a digital electronic circuit system, an integrated circuit system, a field programmable gate array (FPGA), an application-specific integrated circuit (ASIC), an application-specific standard product (ASSP), a system of a system-on-chip (SOC), a complex programmable logic device (CPLD), computer hardware, firmware, software, and/or a combination thereof. These various implementation modes may include: being implemented in one or more computer programs, where the one or more computer programs may be executed and/or interpreted on a programmable system including at least one programmable processor, and the programmable processor may be a dedicated or general-purpose programmable processor which may receive data and instructions from a storage system, at least one input apparatus, and at least one output apparatus, and transmit data and instructions to the storage system, the at least one input apparatus, and the at least one output apparatus.

Program codes for implementing the methods of the present disclosure may be written in any combination of one or more programming languages. These program codes may be provided to a processor or controller of a general-purpose computer, a dedicated computer, or other programmable data processing apparatuses, to cause functions/operations specified in the flowcharts and/or block diagrams to be implemented when the program codes are executed by the processor or the controller. The program codes may be executed entirely on a machine, executed partially on a machine, executed partially on a machine as a stand-alone software package and executed partially on a remote machine or executed entirely on a remote machine or a server.

In the context of the present disclosure, a machine readable medium may be a tangible medium which may contain or store a program for use by or in combination with an instruction execution system, an apparatus, or a device. The machine readable medium may be a machine readable signal medium or a machine readable storage medium. The machine readable medium may include, but is not limited to, an electronic, magnetic, optical, electromagnetic, infrared, or semiconductor system, device, or apparatus, or any suitable combination of the foregoing. More specific examples of the machine readable storage medium may include electrical connections based on one or more wires, a portable computer disk, a hard disk, a random access memory (RAM), a read only memory (ROM), an erasable programmable read only memory (EPROM or a flash memory), an optical fiber, portable compact disk-read only memory (CD-ROM), an optical storage device, a magnetic storage device, or any suitable combination of the foregoing.

To provide interaction with a user, the systems and the techniques described herein may be implemented on a computer having: a display apparatus (e.g., a CRT (cathode ray tube) or LCD (liquid crystal display) monitor) configured to display information to the user; and a keyboard and a pointing apparatus (e.g., a mouse or a trackball) by which the user can provide input to the computer. Other kinds of apparatuses may also be used to provide interaction with the user; for example, a feedback provided to the user may be any form of sensory feedback (e.g., a visual feedback, an auditory feedback, or a haptic feedback); and input from the user may be received in any form (including acoustic input, voice input, or, haptic input).

The systems and the techniques described herein may be implemented in a computing system which includes a back-end component (e.g., as a data server), or a computing system which includes a middleware component (e.g., an application server), or a computing system which includes a front-end component (e.g., a user computer having a graphical user interface or a web browser through which a user can interact with the systems and the techniques described herein), or a computing system which includes any combination of such back-end component, middleware component, or front-end component. Components of a system may be interconnected by digital data communication (e.g., a communication network) in any form or medium. Examples of the communication network include: a local area network (LAN), a wide area network (WAN), and the Internet.

A computer system may include a client and a server. The client and the server are generally far away from each other and usually interact over a communication network. A client-server relationship is created by computer programs which run on corresponding computers and have a client-server relationship with each other. The server may be a cloud server, also referred to as cloud computing server or cloud host, which is a host product in the cloud computing service system to address shortcomings of large management difficulty and weak service scalability in traditional physical hosts and VPS (“Virtual Private Server”, or abbreviated as “VPS”) services. The server may also be a server for a distributed system, or a server in combination with a blockchain.

It should be understood that various forms of the processes shown above may be used, with steps reordered, added or deleted. For example, steps recited in the present disclosure may be executed in parallel or sequentially or in a different order, as long as desired results of technical solutions disclosed in the present disclosure can be achieved, and are not limited herein.

The aforementioned embodiments do not constitute a limitation on protection scope of the present disclosure. It should be apparent to those skilled in the art that various modifications, combinations, sub-combinations and substitutions may be made depending on design requirements and other factors. Any modifications, equivalent substitutions and improvements made within spirit and principles of the present disclosure should be contained in the protection scope of the present disclosure.

1. An image enhancement processing method, comprising:
in response to an input image read, obtaining a color space corresponding to the input image and all color pixels of at least one color component in the color space;
determining sharpened pixel values respectively corresponding to pixel positions of all the color pixels;
determining smoothed sharpened pixel values respectively corresponding to all the pixel positions based on the sharpened pixel values respectively corresponding to the pixel positions of all the color pixels;
obtaining a to-be-coded image corresponding to the input image according to the smoothed sharpened pixel values respectively corresponding to all the pixel positions.

2. The method according to claim 1, wherein determining the sharpened pixel values respectively corresponding to the pixel positions of all the color pixels, comprises:
determining an original pixel value at a pixel position of each color pixel in all the color pixels and a Gaussian mean of all original pixel values in a neighborhood of each color pixel;
determining the sharpened pixel value corresponding to the pixel position of each color pixel according to the original pixel value at the pixel position of each color pixel and the Gaussian mean of all the original pixel values in the neighborhood of each color pixel.

3. The method according to claim 2, wherein determining the sharpened pixel value corresponding to the pixel position of each color pixel according to the original pixel value at the pixel position of each color pixel and the Gaussian mean of all the original pixel values in the neighborhood of each color pixel, comprises:
determining a difference between the original pixel value at the pixel position of each color pixel and the Gaussian mean of all the original pixel values in the neighborhood of each color pixel;
determining the sharpened pixel value corresponding to the pixel position of each color pixel according to a product of the difference and a predetermined scaling factor.

4. The method according to claim 1, wherein determining the smoothed sharpened pixel values respectively corresponding to all the pixel positions based on the sharpened pixel values respectively corresponding to the pixel positions of all the color pixels, comprises:
obtaining a sharpened pixel plane of the at least one color component based on the sharpened pixel values respectively corresponding to the pixel positions of all the color pixels;
determining smoothed sharpened pixel values respectively corresponding to all the pixel positions on the sharpened pixel plane according to all sharpened pixel values of the sharpened pixel plane of the at least one color component.

5. The method according to claim 4, wherein determining the smoothed sharpened pixel values respectively corresponding to all the pixel positions on the sharpened pixel plane according to all the sharpened pixel values of the sharpened pixel plane of the at least one color component, comprises:
determining the smoothed sharpened pixel values respectively corresponding to all the pixel positions on the sharpened pixel plane according to a Gaussian mean of all the sharpened pixel values of the sharpened pixel plane of the at least one color component.

6. The method according to claim 1, wherein obtaining the to-be-coded image corresponding to the input image according to the smoothed sharpened pixel values respectively corresponding to all the pixel positions, comprises:
obtaining to-be-coded pixel values respectively corresponding to all the pixel positions according to original pixel values respectively corresponding to all the pixel positions and the smoothed sharpened pixel values respectively corresponding to all the pixel positions;
obtaining a to-be-coded pixel plane of the at least one color component based on the to-be-coded pixel values respectively corresponding to all the pixel positions;
obtaining the to-be-coded image corresponding to the input image based on the to-be-coded pixel plane of the at least one color component.

7. The method according to claim 6, wherein obtaining the to-be-coded pixel values respectively corresponding to all the pixel positions according to the original pixel values respectively corresponding to all the pixel positions and the smoothed sharpened pixel values respectively corresponding to all the pixel positions, comprises:
acquiring a bit depth of the input image and an effective range corresponding to the bit depth;
determining a sum value of the original pixel values and the smoothed sharpened pixel values respectively corresponding to all the pixel positions;
if a sum value corresponding to any one of the pixel positions exceeds the effective range, truncating the sum value that exceeds the effective range to the effective range to obtain the to-be-coded pixel values respectively corresponding to all the pixel positions.

8. The method according to claim 1, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

9-19. (canceled)

20. The method according to claim 2, wherein obtaining the color space corresponding to the input image, comprises:
obtaining an initial color space of the input image; if the initial color space is not a target color space, performing conversion processing on the initial color space to obtain the color space corresponding to the input image;
if the initial color space is the target color space, taking the target color space as the color space corresponding to the input image.

21. The method according to claim 3, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

22. The method according to claim 4, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

23. The method according to claim 5, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

24. The method according to claim 6, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

25. The method according to claim 7, wherein obtaining the color space corresponding to the input image, comprises:
obtaining an initial color space of the input image;
if the initial color space is not a target color space, performing conversion processing on the initial color space to obtain the color space corresponding to the input image;
if the initial color space is the target color space, taking the target color space as the color space corresponding to the input image.

26. An electronic device, comprising:
at least one processor; and
a memory communicatively connected with the at least one processor;
wherein the memory stores an instruction executable by the at least one processor, and the instruction is executed by the at least one processor to enable the at least one processor to:
obtain, in response to an input image read, a color space corresponding to the input image and all color pixels of at least one color component in the color space;
determine sharpened pixel values respectively corresponding to pixel positions of all the color pixels;
determine smoothed sharpened pixel values respectively corresponding to all the pixel positions based on the sharpened pixel values respectively corresponding to the pixel positions of all the color pixels;
obtain a to-be-coded image corresponding to the input image according to the smoothed sharpened pixel values respectively corresponding to all the pixel positions.

27. The electronic device according to claim 26, wherein the at least one processor is enabled to:
determine an original pixel value at a pixel position of each color pixel in all the color pixels and a Gaussian mean of all original pixel values in a neighborhood of each color pixel;
determine the sharpened pixel value corresponding to the pixel position of each color pixel according to the original pixel value at the pixel position of each color pixel and the Gaussian mean of all the original pixel values in the neighborhood of each color pixel.

28. The electronic device according to claim 26, wherein the at least one processor is enabled to:
obtain a sharpened pixel plane of the at least one color component based on the sharpened pixel values respectively corresponding to the pixel positions of all the color pixels;
determine smoothed sharpened pixel values respectively corresponding to all the pixel positions on the sharpened pixel plane according to all sharpened pixel values of the sharpened pixel plane of the at least one color component.

29. The electronic device according to claim 26, wherein the at least one processor is enabled to:
obtain to-be-coded pixel values respectively corresponding to all the pixel positions according to original pixel values respectively corresponding to all the pixel positions and the smoothed sharpened pixel values respectively corresponding to all the pixel positions;
obtain a to-be-coded pixel plane of the at least one color component based on the to-be-coded pixel values respectively corresponding to all the pixel positions;
obtain the to-be-coded image corresponding to the input image based on the to-be-coded pixel plane of the at least one color component.

30. The electronic device according to claim 26, wherein the at least one processor is enabled to:
acquire an initial color space of the input image;
perform conversion processing on the initial color space to obtain the color space corresponding to the input image, if the initial color space is not a target color space;
take the target color space as the color space corresponding to the input image, if the initial color space is the target color space.

31. A non-transitory computer readable storage medium with a computer instruction stored thereon, wherein the computer instruction is configured to enable a computer to:
obtain, in response to an input image read, a color space corresponding to the input image and all color pixels of at least one color component in the color space;
determine sharpened pixel values respectively corresponding to pixel positions of all the color pixels;
determine smoothed sharpened pixel values respectively corresponding to all the pixel positions based on the sharpened pixel values respectively corresponding to the pixel positions of all the color pixels;
obtain a to-be-coded image corresponding to the input image according to the smoothed sharpened pixel values respectively corresponding to all the pixel positions.
